(19) United States
(12) Patent Application Publication
(10) Pub. No.: US 2017/0054316 A1
(43) Pub. Date: Feb. 23, 2017

(54) SYSTEM AND METHOD OF CHARGING BATTERY

(71) Applicant: Caterpillar Inc., Peoria, IL (US)

(72) Inventor: Igor A. Francis-Buller, Peoria Heights, IL (US)

(73) Assignee: Caterpillar Inc., Peoria, IL (US)

(21) Appl. No.: 14/832,375

(22) Filed: Aug. 21, 2015

(51) Int. Cl. H02J 7/00; H02J 7/14

(52) U.S. Cl. CPC H02J 7/0057; H02J 7/14

(57) ABSTRACT

A smart control system for charging a battery is provided. The smart control system includes a charging system electrically coupled to the battery to provide an output to the battery. The smart control system also includes a control module communicably coupled to the charging system and the battery. The control module is configured to monitor at least one of a state of health (SOH) of the battery and a state of charge (SOC) of the battery. The control module is also configured to monitor a temperature of the battery. The control module is further configured to control the output provided by the charging system to the battery based on the monitored temperature and at least one of the SOH and the SOC of the battery.

### TECHNICAL FIELD

The present disclosure relates to a system and method of charging a battery, and more particularly to the system and method of charging the battery by electrically connecting the battery to a charging system.

### BACKGROUND

As new technologies are implemented on machines, electrical loads have increased significantly. The machines generally include batteries that are used to start the machine as well as supplement electrical loads of the machine when required. The batteries are also used to supply load for peripheral systems when the engine is off. The batteries are generally embodied as chargeable batteries that are charged after the batteries exhaust their existing charge. Efficient charging of the batteries is important as the batteries are typically configured to start the engine in addition to other machine components. A charging system is generally associated with the batteries. As per requirements, the charging system may charge the battery. However, in some situations the battery may be undercharged or overcharged, thereby decreasing a life of the battery.

U.S. Pat. No. 7,928,735 describes improvements both in the methods whereby existing techniques for determining the condition of a battery are communicated to a user, for example, to the owner of a private vehicle, or to the service manager of a fleet of vehicles, or the vehicle's operating system, and in the methods for evaluating the condition of the battery are disclosed. The disclosure relates in part to instruments and corresponding methods for evaluating the condition of a battery utilizing this discovery.

### SUMMARY OF THE DISCLOSURE

In one aspect of the present disclosure, a smart control system for charging a battery is provided. The smart control system includes a charging system electrically coupled to the battery to provide an output to the battery. The smart control system also includes a control module communicably coupled to the charging system and the battery. The control module is configured to monitor at least one of a state of health (SOH) of the battery and a state of charge (SOC) of the battery. The control module is also configured to monitor a temperature of the battery. The control module is further configured to control the output provided by the charging system to the battery based on the monitored temperature and at least one of the SOH and the SOC of the battery.

In another aspect of the present disclosure, a method of charging a battery electrically connected to a charging system is provided. The method includes providing an output from the charging system to the battery. The method also includes monitoring at least one of a state of health (SOH) of the battery and a state of charge (SOC) of the battery. The method further includes monitoring a temperature of the battery. The method includes controlling the output provided to the battery based on the monitored temperature and at least one of the SOH and the SOC of the battery.

In yet another aspect of the present disclosure, a method of charging a battery is provided. The method includes providing a charging current to the battery in one of an equalization state, an absorption state, and a bulk charge state. The method also includes monitoring a plurality of charging parameters of the battery, the plurality of charging parameters comprising a state of charge (SOC), a state of health (SOH), a temperature, a voltage, and a current of the battery. The method further includes determining a first SOC range and a second SOC range based at least on the SOH of the battery, the second SOC range less than the second SOC range. The method includes determining a first voltage range and a second voltage range less than the first voltage range. The method also includes operating the battery in the equalization state if the SOC falls in the first SOC range and the voltage of the battery falls in the first voltage range. The method further includes operating the battery in the absorption state if the SOC falls in the second SOC range and the voltage falls in the second voltage range. The method includes operating the battery in the bulk charge state if the SOC is less than the second SOC range and the voltage is less then the second voltage range.

Other features and aspects of this disclosure will be apparent from the following description and the accompanying drawings.

### BRIEF DESCRIPTION OF THE DRAWINGS

FIG. 1 is a block diagram depicting an exemplary smart control system for charging a battery, according to one embodiment of the present disclosure;

FIG. 2 is an exemplary flowchart implemented by a control module of the smart control system of FIG. 1 for charging the battery, according to one embodiment of the present disclosure;

FIG. 3 is a flowchart of a method for charging the battery, according to one embodiment of the present disclosure; and

FIG. 4 is a flowchart of another method for charging the battery, according to another embodiment of the present disclosure.

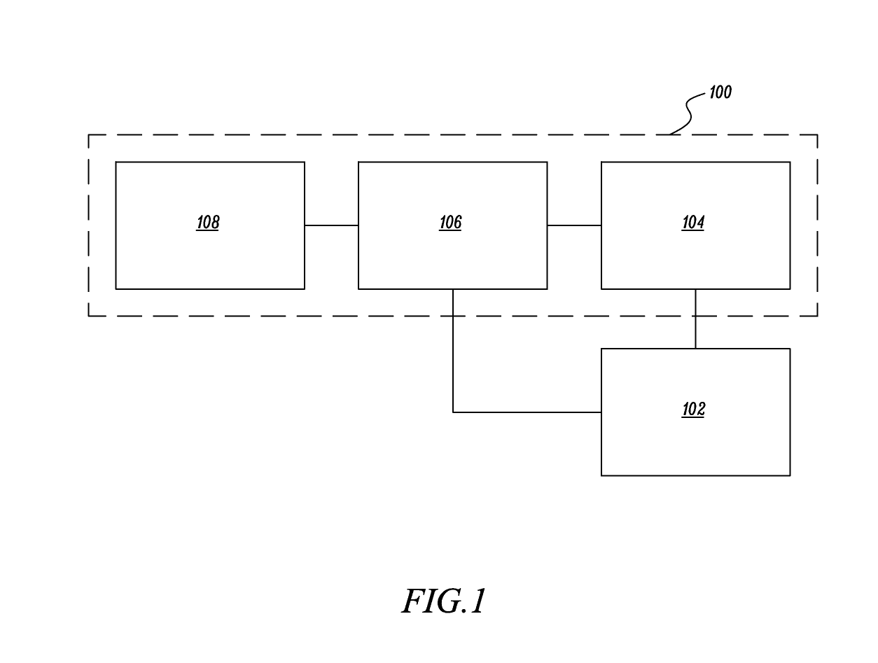

### DETAILED DESCRIPTION

Wherever possible, the same reference numbers will be used throughout the drawings to refer to the same or the like parts. FIG. 1 is a block diagram illustrating an exemplary smart control system 100 for charging a battery 102. The battery 102 may be associated with any of a stationary machine (not shown) such as, an electrical generator, in order to power one or more electrical components of the stationary machine. Alternatively, the battery 102 may be associated with a moving machine. The moving machine may include construction machinery, transportation vehicles, and the like. The construction machine may include any one of a track type tractor, electric mining truck, backhoe loader, and the like.

In one embodiment, the battery 102 may provide motive power to the moving machine. In another embodiment, the battery 102 may provide electric power to start an engine of the moving machine. In other embodiment, the battery 102 may be used to supplement the electrical load of the moving machine when an alternator associated with the moving machine is not able to supply required load. The batteries are also used to supply load for peripheral systems when the engine is off. In one exemplary embodiment, the battery 102 provides electrical power to a micro-grid (not shown). In various embodiments, the battery 102 may power electrical power to any electrical component without limiting the scope of the present disclosure.

The smart control system 100 includes a charging system 104. The charging system 104 is electrically coupled with the battery 102. The charging system 104 provides an output to the battery 102. The output is a charging current provided by the charging system 104. In one example, the charging system 104 is embodied as an alternator. Alternatively, the charging system 104 may include a generator, or any other system that is capable of charging the battery 102, without any limitations. The charging system 104 may include standard components that allow charging of the battery 102.

The smart control system 100 also includes a control module 106. The control module 106 may embody any Electronic Control Unit (ECU) known in the art that is capable of receiving signals, analyzing the received signals, making decisions based on the analysis, and transmitting results of the analysis in order to control one or more components of the smart control system 100.

The control module 106 is communicably coupled to the charging system 104 and the battery 102. The control module 106 is capable of sending and receiving signals from the charging system 104 and the battery 102. The control module 106 monitors a number of charging parameters. The charging parameters include one or more of a state of charge (SOC), a state of health (SOH), a temperature, a voltage, and a current of the battery 102.

In one example, the control module 106 monitors the SOH of the battery 102. The term “SOH” is indicative of a performance of the battery 102. The control module 106 also monitors the SOC of the battery 102. The term “SOC” is indicative of a current state of charge in the battery 102. The SOH, the SOC, and the temperature of the battery 102 may be determined using any known direct or indirect method of determination, without any limitations. In one example, a sensing module 108 is communicably coupled with the control module 106. In one example, the sensing module 108 is mounted on the battery 102. The sensing module 108 may include battery sensors that may determine the SOH, the SOC, the temperature, the voltage, and the current of the battery 102. The sensing module 108 may include combination of hardware and/or software components capable of monitoring the SOH, the SOC, the temperature, the voltage, and the current of the battery 102.

The sensing module 108 detects and transmits data corresponding to the SOH, the SOC, the temperature, the voltage, and the current of the battery 102 to the control module 106. According to one embodiment of the present disclosure, the control module 106 includes logics to determine and control the output provided by the charging system 104 to the battery 102. More particularly, based on the monitored temperature of the battery 102 and at least one of the SOH and the SOC of the battery 102, the control module 106 sends signals to the charging system 104 in order to control the output provided to the battery 102. Further, the control module 106 also monitors the voltage of the battery 102 and the current of the battery 102. Based on the measured voltage and current, the control module 106 controls the output provided to the battery 102. In another example, the control module 106 may itself have capabilities to read the charging parameters and determine the SOC and the SOH of the battery 102.

According to another exemplary embodiment, the control module 106 of the smart control system 100 controls a state of operation of the battery 102. In one example, based on the monitored temperature of the battery 102 and at least one of the SOH and the SOC of the battery 102, the control module 106 sends signals to the charging system 104 to operate the battery 102 in one of an equalization state, an absorption state, and a bulk charge state. In one example, the control module 106 determines a first SOC range and a second SOC range based at least on the SOH of the battery 102, such that the first SOC range is greater than the second SOC range. In one example, the first SOC range may be approximately between 90% and 100%, whereas the second SOC range may be approximately between 80% and 90%. Further, the control module 106 also determines a first voltage range and a second voltage range, such that the second voltage range is less than the first voltage range. In one example, the first voltage range may be approximately between 25.54 V and 28.4 V. Moreover, the second voltage range may be approximately between 22.7 V and 25.54 V.

In a situation where the determined SOC of the battery 102 falls in the first SOC range and the voltage of the battery 102 falls in the first voltage range, the control module 106 sends signals to the charging system 104 in order to operate the battery 102 in the equalization state. In another situation where the SOC of the battery 102 falls in the second SOC range and the voltage falls in the second voltage range, the control module 106 sends signals to the charging system 104 to operate the battery 102 in the absorption state. Moreover, when the SOC is less than the second SOC range and the voltage is less than the second voltage range, the control module 106 sends signals to the charging system 104 such that the battery 102 operates in the bulk charge state.

As discussed earlier, the control module 106 determines the voltage of the battery 102. In one example, the control module 106 determines a maximum voltage of the battery 102 for each of the corresponding equalization state, absorption state, and bulk charge state. The maximum voltage is determined based at least on the monitored temperature of the battery 102. In a situation wherein the determined maximum voltage is lesser than the maximum voltage for each of the corresponding equalization state, absorption state, and bulk charge state, the control module 106 sends signals to the charging system 104 to control the output to the battery 102. More particularly, the output provided to the battery 102 is controlled until the voltage of the battery 102 reaches the maximum voltage for the respective equalization state, absorption state, and bulk charge state.

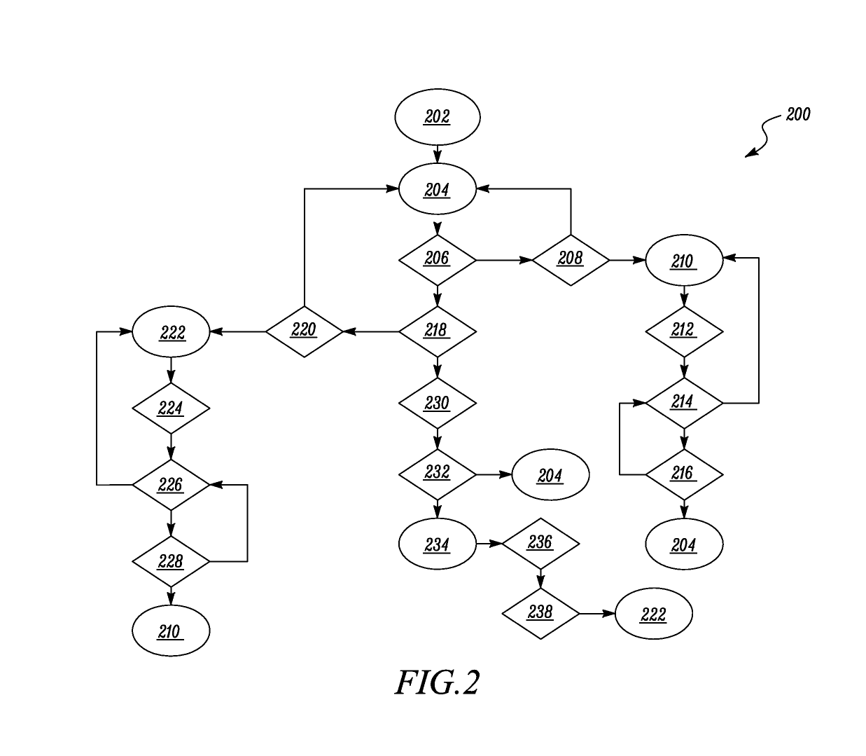

In one exemplary embodiment, the control module 106 switches between the operation states, based on the corresponding voltages and currents. In one example, when the battery 102 is operating in the absorption state, the control module 106 sends signals to the charging system 104 to switch the operation of the battery 102 from the absorption state to the equalization state. More particularly, if the voltage of the battery 102 reaches the corresponding maximum voltage limit and the current of the battery 102 is less than a first current limit, the control module 106 sends signals to the charging system 104 in order to switch the operation of the battery 102 from the absorption state to the equalization state. In another example wherein the battery 102 is operating in the bulk charge state, the control module 106 sends signals to the charging system 104 to switch the operation of the battery 102 from the bulk charge state to the absorption state. More particularly, if a voltage of the battery 102 reaches the corresponding maximum voltage limit and the current of the battery 102 is less than a second current limit, the control module 106 sends signals to the charging system 104 to switch the operation of the battery 102 from the bulk charge state to the absorption state. A working of the smart control system 100 will now be explained in detail with reference to FIG. 2.

FIG. 2 is an exemplary process 200 or algorithm that may be stored in the control module 106 in order to identify and change the operation state of the battery 102. Alternatively, the process 200 may also be stored in an Electronic Control Module (ECM) present on-board the machine, and may be retrieved by the control module 106 therefrom. The process 200 begins at step 202 in which the method implemented by the control module 106 or the ECM starts or begins operation. At step 204, based on the signals received from the sensing module 108, the control module 106 determines the SOC of the battery 102. On determining the SOC of the battery 102, the process 200 moves to step 206. At step 206, the control module 106 determines whether the SOC of the battery 102 is within the first SOC range.

In an example wherein the SOC of the battery 102 is within the first SOC range, the process 200 moves to step 208. At step 208, the control module 106 determines if the voltage of the battery 102 falls within the first voltage range. If the voltage of the battery 102 determined at step 206, does not fall within the first voltage range, the process 200 moves to step 204. However, if the voltage of the battery 102 falls within the first voltage range, the process 200 moves to step 210. At step 210, the control module 106 sends signals to the charging system 104 to operate the battery 102 in the equalization state. As the battery 102 operates in the equalization state, the process 200 moves to step 212 in order to determine the maximum voltage of the battery 102, based at least on the monitored temperature. Further, once the maximum voltage is determined at step 212, the process 200 moves on to step 214. At step 214, the control module 106 determines whether the battery 102 has reached or exceeded the maximum voltage corresponding to the equalization state. In one example, the control module 106 may determine whether the maximum voltage of the battery 102 is greater than 30 V.

In a situation wherein the process 200 determines that the maximum voltage corresponding to the equalization state is not reached, the process 200 moves to step 210. However, if the maximum voltage corresponding to the equalization state is reached, the process 200 moves to step 216. At step 216, the process 200 determines whether the current at the battery 102 lies within a third current limit. If the current of the battery 102 is less than the third current limit, the process 200 moves to step 204. However, in a situation wherein the current at the battery 102 does not fall within the third current limit, the process 200 moves to step 214.

Referring to the accompanying figures, in an example wherein the SOC of the battery 102 does not fall in the first SOC range, the process 200 moves to step 218. At step 218, the control module 106 determines whether the SOC is in the second SOC range. If the SOC is in the second SOC range, the process 200 moves to step 220. At step 220, the control module 106 determines if the voltage of the battery 102 falls in the first voltage range. If the voltage does not fall within the first voltage range the process 200 moves to step 204. However, if the voltage lies within the first voltage range, the process 200 moves to step 222. At step 222, the control module 106 sends signals to the charging system 104 to operate the battery 102 in the absorption state.

Further, as the process 200 moves to step 224 the control module 106 determines the maximum voltage of the battery 102 based at least on the monitored temperature. Once the maximum voltage is determined at step 224, the process 200 moves to step 226. At step 226, the control module 106 determines whether the ideal maximum voltage corresponding to the absorption state is reached. In one example, the maximum voltage may be approximately greater than or equal to 30 V. If the maximum voltage corresponding to the absorption state is not reached, the process 200 moves to step 222. However, if the control module 106 determines that the maximum voltage corresponding to the absorption state is reached, the process 200 moves to step 228. At step 228, the control module 106 determines whether the current at the battery 102 is less than first current limit. If the current is lesser than the first current limit, the process 200 moves to step 210. At step 210, the control module 106 sends signals to the charging system 104 in order to switch the operation of the battery 102 from the absorption state to the equalization state. However, if the current is greater than the first current limit the process 200 moves to step 226.

In a situation wherein the SOC does not lie within the second SOC range, the process 200 moves to step 230. At step 230, the control module 106 determines whether the SOC falls in a third SOC range, the third SOC range may be approximately between 0% and 80%. If the control module 106 determines that the SOC lies in the third SOC range, the process 200 moves to step 232. At step 232, the control module 106 determines if the voltage of the battery 102 falls in a second voltage range. The second voltage range may be approximately between 0 V and 22.7 V. If the voltage is greater than the second voltage range, the process 200 moves to step 204. However, if the voltage of the battery 102 is less than the second voltage range, the process 200 moves to step 234. As step 234, the control module 106 sends signals to the charging system 104 to operate the battery 102 in the bulk charge state.

Further, at step 236, the control module 106 determines the maximum voltage of the battery 102 corresponding to the bulk charge state. If the control module 106 determines that the maximum voltage of the battery 102 corresponding to the bulk charge state is reached, the process 200 moves to step 238. In one example, the maximum voltage for the bulk charge state may correspond to 29.6 V.

At step 238, the control module 106 determines whether the SOC of the battery 102 is equal to 80%. If the SOC of the battery is equal to 80%, the process 200 moves to step 222. At step 222, the control module 106 sends signals to the charging system 104 to switch the operation of the battery 102 from the bulk charge state to the absorption state. However, if the SOC of the battery is lesser than 80%, the process 200 moves to step 234.

### INDUSTRIAL APPLICABILITY

The present disclosure relates to the smart control system 100 to control the output of the charging system 104 to charge the battery 102 at an optimal level. The smart control system 100 determines charging parameters, such as the SOC, the SOH, the temperature, the voltage, and the current of the battery 102 to control the output of the charging system 104. Further, the smart control system 100 also utilizes the readings corresponding to the charging parameters to prevent overcharging and undercharging of the battery 102, thereby prolonging battery life. The smart control system 100 disclosed herein allows efficient charging of the battery 102. Thus, the battery 102 may reliably handle system loads, thereby decreasing downtime at customer end and also reducing significant financial losses. Further, the smart control system 100 allows variation in the output of the charging system 104, based on system requirements. For example, the output of the charging system 104 may vary, and can be equal to 12 V, 24 V, 48 V, etc.

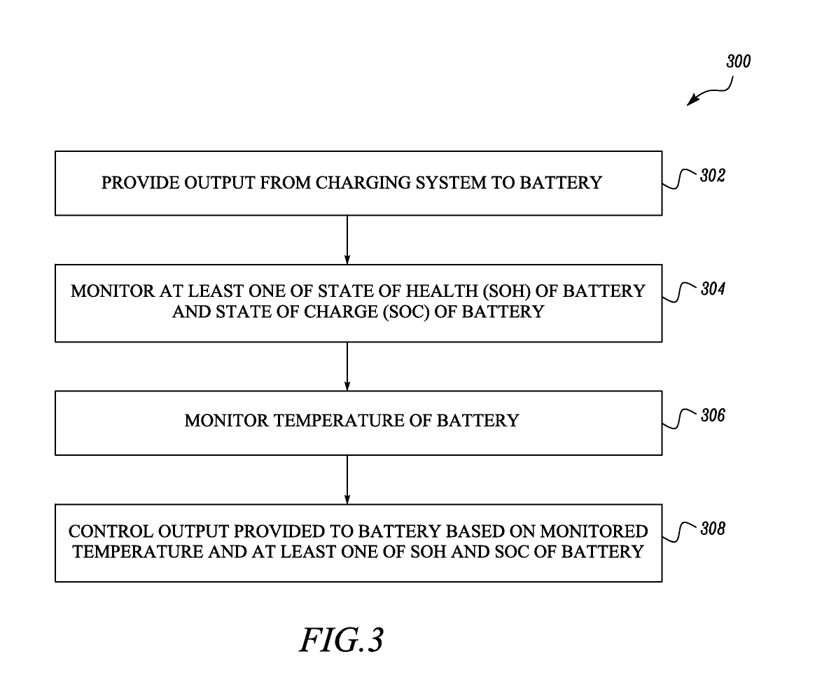

Referring to FIG. 3, a method 300 of charging the battery 102 electrically connected to the charging system 104 is provided. In one example, the battery 102 provides electrical power to the engine. At step 302, the charging system 104 provides the output to the battery 102. The output is the charging current that is provided to the battery 102 in order to charge the battery 102. At step 304, the control module 106 monitors at least on of the SOH and the SOC of the battery 102. At step 306, the control module 106 monitors the temperature of the battery 102. At step 308, the control module 106 controls the output provided to the battery 102 by the charging system 104, based on the monitored temperature and at least one of the SOH and the SOC of the battery 102.

The control module 106 also determines the maximum voltage for the battery 102 based at least on the monitored temperature of the battery 102. Based on the determination, the control module 106 sends signals to the charging system 104 to control the output provided to the battery 102 until the voltage of the battery 102 reaches the maximum voltage. In another embodiment, the control module 106 also monitors the voltage and the current of the battery 102. Based on at least one of the voltage and the current of the battery 102, the control module 106 controls the output provided by the charging system 104 to the battery 102.

The control module 106 disclosed herein sends signals to the charging system 104 in order to operate the battery 102 in one of the equalization state, the absorption state, and the bulk charge state, based on the monitored temperature and at least one of the SOH and the SOC of the battery 102. For this purpose, the control module 106 determines the first SOC range and the second SOC range based at least on the SOH of the battery 102, wherein the second SOC range is less than the second SOC range. Further, the control module 106 also determines the first voltage range and the second voltage range for the battery 102, such that the second voltage range is less than the first voltage range.

In an example wherein the SOC falls in the first SOC range and the voltage of the battery 102 falls in the first voltage range, the control module 106 sends signals to the charging system 104 to operate the battery 102 in the equalization state. Further, if the SOC falls in the second SOC range and the voltage falls in the second voltage range, the control module 106 sends signals to the charging system 104 in order to operate the battery 102 in the absorption state. Moreover, the control module 106 sends signals to the charging system 104 to switch the operation of the battery 102 from the absorption state to the equalization state if the voltage of the battery 102 reaches the corresponding maximum voltage limit and the current of the battery 102 is less than the first current limit.

Further, the control module 106 sends signals to the charging system 104 to operate the battery 102 in the bulk charge state if the SOC of the battery 102 is less than the second SOC range and the voltage is less than the second voltage range. Further, the control module 106 sends signals to the charging system 104 to switch the operation of the battery 102 from the bulk charge state to the absorption state if the voltage of the battery 102 reaches the corresponding maximum voltage limit and the current of the battery 102 is less than the second current limit.

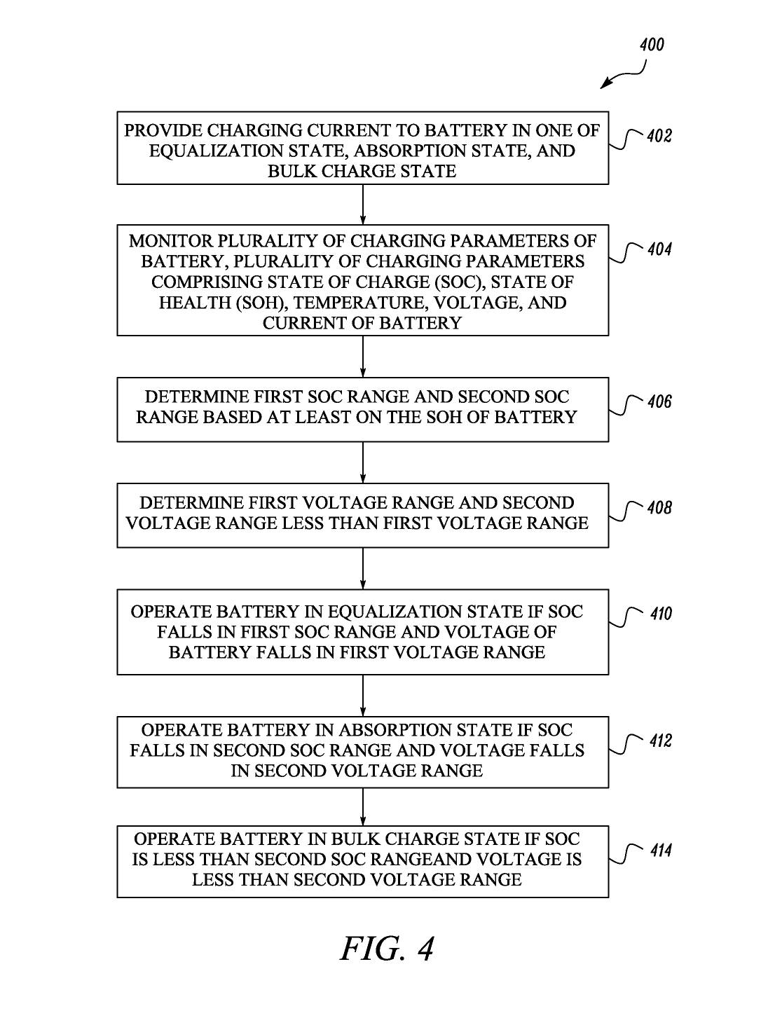

FIG. 4 is a flowchart for another method 400 of charging the battery 102. At step 402, the charging system 104 provides the charging current to the battery 102 in one of the equalization state, the absorption state, and the bulk charge state. At step 404, the control module 106 monitors the charging parameters of the battery 102, the charging parameters may include the SOC, the SOH, the temperature, the voltage, and the current of the battery 102. At step 406, the control module 106 determines the first SOC range and the second SOC range based at least on the SOH of the battery 102, wherein the second SOC range is less than the first SOC range. At step 408, the control module 106 determines the first voltage range and the second voltage range, such that the second voltage range is less than the first voltage range.

At step 410, the control module 106 sends signals to the charging system 104 to operate the battery 102 in the equalization state if the SOC falls in the first SOC range and the voltage of the battery 102 falls in the first voltage range. At step 412, the control module 106 sends signals to the charging system 104 to operate the battery 102 in the absorption state if the SOC falls in the second SOC range and the voltage of the battery 102 falls in the second voltage range. At step 414, the control module 106 sends signals to the charging system 104 to operate the battery 102 in the bulk charge state if the SOC is less than the second SOC range and the voltage is less than the second voltage range. More particularly, the control module 106 sends signals to the charging system 104 to operate the battery 102 in the bulk charge state if the SOC is in the third SOC range and the voltage is less than the second voltage range. The control module 106 also determines the maximum voltage for the battery 102 for each of the corresponding equalization state, the absorption state, or the bulk charge state, based at least on the monitored temperature. Based on the determination, the control module 106 sends signals to the charging system 104 to control the charging current provided to the battery 102 to reach the respective maximum voltage for the equalization state, the absorption state, and the bulk charge state.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A smart control system for charging a battery, the smart control system comprising:
a charging system electrically coupled to the battery to provide an output to the battery;
a control module communicably coupled to the charging system and the battery, the control module configured to:
monitor at least one of a state of health (SOH) of the battery, and a state of charge (SOC) of the battery;
monitor a temperature of the battery; and
control the output provided by the charging system to the battery based on the monitored temperature and at least one of the SOH and the SOC of the battery.

2. The smart control system of claim 1, wherein the charging system is an alternator.

3. The smart control system of claim 1, wherein the control module is further configured to:
monitor a voltage of the battery and a current of the battery; and
control the output provided to the battery further based on at least one of the voltage and the current.

4. The smart control system of claim 1, wherein the control module is further configured to operate the battery in one of an equalization state, an absorption state and a bulk charge state based on the monitored temperature and at least one of the SOH and the SOC of the battery.

5. The smart control system of claim 4, wherein the control module is further configured to:
determine a first SOC range and a second SOC range based at least on the SOH of the battery, the first SOC range greater than the second SOC range;
determine a first voltage range and a second voltage range less than the first voltage range;
operate the battery in the equalization state if the SOC falls in the first SOC range and a voltage of the battery falls in the first voltage range;
operate the battery in the absorption state if the SOC falls in the second SOC range and the voltage falls in the second voltage range;
operate the battery in the bulk charge state if the SOC is less than the second SOC range and the voltage is less than the second voltage range.

6. The smart control system of claim 4, wherein the control module is further configured to:
determine a maximum voltage for the battery for each of the corresponding equalization state, the absorption state or the bulk charge state based at least on the monitored temperature; and
control the output provided to the battery to reach the maximum voltage for the respective equalization state, the absorption state and the bulk charge state.

7. The smart control system of claim 6, wherein the control module is further configured to switch from the absorption state to the equalization state if a voltage of the battery reaches the corresponding maximum voltage limit and a current of the battery is less than a first current limit.

8. The smart control system of claim 6, wherein the control module is further configured to switch from the bulk charge state to the absorption state if a voltage of the battery reaches the corresponding maximum voltage limit and a current of the battery is less than a second current limit.

9. The smart control system of claim 1, wherein the battery is configured to provide electrical power to an engine and a micro-grid.

10. A method of charging a battery electrically connected to a charging system, the method comprising:
providing an output from the charging system to the battery;
monitoring at least one of a state of health (SOH) of the battery and a state of charge (SOC) of the battery;
monitoring a temperature of the battery; and
controlling the output provided to the battery based on the monitored temperature and at least one of the SOH and the SOC of the battery.

11. The method of claim 10, wherein the output is a charging current provided by the charging system.

12. The method of claim 10 further comprising:
monitoring a voltage of the battery and a current of the battery; and
controlling the output provided to the battery further based on at least one of the voltage and the current of the battery.

13. The method of claim 10 further comprising:
determining a maximum voltage for the battery based at least on the monitored temperature of the battery; and
providing the output to the battery until a voltage of the battery reaches the maximum voltage.

14. The method of claim 10 further comprising operating the battery in one of an equalization state, an absorption state and a bulk charge state based on the monitored temperature and at least one of the SOH and the SOC of the battery.

15. The method of claim 14 further comprising:
determining a first SOC range and a second SOC range based at least on the SOH of the battery, the second SOC range less than the second SOC range;
determining a first voltage range and a second voltage range less than the first voltage range;
operating the battery in the equalization state if the SOC falls in the first SOC range and a voltage of the battery falls in the first voltage range;
operating the battery in the absorption state if the SOC falls in the second SOC range and the voltage falls in the second voltage range;
operating the battery in the bulk charge state if the SOC is less than the second SOC range and the voltage is less than the second voltage range.

16. The method of claim 10, wherein the battery is configured to provide electrical power to an engine.

17. The method of claim 14 further comprising:
switching from the absorption state to the equalization state if a voltage of the battery reaches the corresponding maximum voltage limit and a current of the battery is less than a first current limit;
switching from the bulk charge state to the absorption state if a voltage of the battery reaches the corresponding maximum voltage limit and a current of the battery is less than a second current limit.

18. A method of charging a battery, the method comprising:
providing a charging current to the battery in one of an equalization state, an absorption state and a bulk charge state;
monitoring a plurality of charging parameters of the battery, the plurality of charging parameters comprising a state of charge (SOC), a state of health (SOH), a temperature, a voltage, and a current of the battery;
determining a first SOC range and a second SOC range based at least on the SOH of the battery, the second SOC range less than the second SOC range;
determining a first voltage range and a second voltage range less than the first voltage range;
operating the battery in the equalization state if the SOC falls in the first SOC range and the voltage of the battery falls in the first voltage range;
operating the battery in the absorption state if the SOC falls in the second SOC range and the voltage falls in the second voltage range; and
operating the battery in the bulk charge state if the SOC is less than the second SOC range and the voltage is less than the second voltage range.

19. The method of claim 18 further comprising:
determining a maximum voltage for the battery for each of the corresponding equalization state, the absorption state or the bulk charge state based at least on the monitored temperature; and
controlling the charging current provided to the battery to reach the respective maximum voltage for the equalization state, the absorption state and the bulk charge state.

20. The method of claim 18, wherein the battery is configured to provide power to an engine.
